(19) United States
(12) Patent Application Publication
(10) Pub. No.: US 2014/0229582 A1
(43) Pub. Date: Aug. 14, 2014

(54) System And Method For Offline Downloading Network Resource Files

(71) Applicant: TENCENT TECHNOLOGY (SHENZHEN) COMPANY LIMITED, Shenzhen (CN)

(72) Inventors: Gang LIU, Shenzhen City (CN); Fuchen WANG, Shenzhen (CN); Yan HUANG, Shenzhen City (CN)

(73) Assignee: TENCENT TECHNOLOGY (SHENZHEN) COMPANY LIMITED, Shenzhen (CN)

(21) Appl. No.: 14/257,058

(22) Filed: Apr. 21, 2014

Related U.S. Application Data
(63) Continuation of application No. PCT/CN2012/083973, filed on Nov. 2, 2012.

(30) Foreign Application Priority Data
Nov. 24, 2011 (CN) CN201110377975.2

(51) Int. Cl. H04L 29/08; G06F 17/30

(52) U.S. Cl. CPC H04L 67/06; G06F 17/30109
USPC 709/219

(57) ABSTRACT

An offline downloading server side logically divides a destination file requesting to be downloaded offline into more than one segmented file to be downloaded offline, and monitors downloading state of each segmented file. When at least one segmented file has been downloaded offline, the offline downloading server side may inform the downloading client to download. The downloading client may download the segmented file, offline downloading of which has been completed, from the offline downloading server side.

### CROSS-REFERENCE TO RELATED APPLICATIONS

This application is a continuation of international application number PCT/CN2012/083973 filed on Nov. 2, 2012. This application claims the benefit and priority of Chinese application number 201110377975.2, filed Nov. 24, 2011. The entire disclosures of each of the above applications are incorporated herein by reference.

### FIELD

The present disclosure relates to network data communication technologies, and more particularly, to a system and method for offline downloading network resource files.

### BACKGROUND

This section provides background information related to the present disclosure which is not necessarily prior art.

Network resources generally refer to digital resources stored by network, which are provided for users to download and use. The foregoing digital resources may include program files, video files, audio files, and so on. At present, common modes to download network resources may include the following.

Based on Peer to Server (P2S) technologies, all of the network resources may be stored to a server of a large downloading website. Users may directly access the website to download resource files. By using the P2S technologies, downloading speed may be guaranteed. However, resources may be scattered and difficult to be searched.

Peer-to-Peer (P2P) technologies may be referred to as peer technologies, which may rely on computing capability and bandwidth of a device participating in downloading network resources, instead of totally relying on a few servers. The P2P technologies have been popularly used in the aspects of sharing and downloading files. The downloading speed of one side of the P2P is closely related with uploading speed of the other side. Most Chinese users use the Asymmetric Digital Subscriber Line (ADSL) to access the Internet, and uploading speed of the ADSL is not fast, possibly less than 100 K. Furthermore, some users may limit the uploading speed manually; as a result, uploading bandwidth resources of the P2P mode may be limited. Thus, users may generally consider that the P2P speed is very slow.

Based on Peer to Server & Peer (P2SP) technologies, downloading may not totally rely on servers as in a traditional mode. The transfer of contents may be executed by each terminal machine of a network. In addition to including P2P, the P2SP may also include a server, that is, the “S” in the P2SP. The P2SP technologies have effectively integrated an originally isolated server with mirroring resources thereof and P2P resources. Compared with traditional P2P or P2S, downloading stability and downloading speed of P2SP have been greatly improved. Based on the mechanism of user to server and user, unlike the P2P and P2S, the P2SP supports P2P technologies and integrates server resources with P2P resources by searching in a Data Base (DB). When a user downloads a file, other resources may be automatically searched for and appropriate resources may be selected to accelerate the download process. Subsequently, compared with traditional P2P, the downloading stability and downloading speed of the P2SP technologies may be greatly improved

Based on the P2SP technologies, when downloading a network resource file, data source may be divided into a source downloading link, a P2P network, and auxiliary source of a third party image. The file may be connected in a series uniformly by using a unique identifier of the complete file. The unique identifier may be obtained after calculating with a Message Digest Algorithm (MD5) or Secure Hash Algorithm (SHA).

### SUMMARY

This section provides a general summary of the disclosure, and is not a comprehensive disclosure of its full scope or all of its features.

In view of above, the main objectives of the present disclosure are to provide a method and system for offline downloading network resource files, so as to shorten the overall downloading time of network resource files.

Technical solutions of the present disclosure may be implemented as follows.

A system for offline downloading a network resource file includes a downloading client, an offline task management server, an offline downloading server, a cloud storage server, and a file dividing and segmenting server, wherein:

the downloading client is configured to initiate an offline downloading task request and download a segmented file, which has been downloaded offline from the cloud storage server;

the offline task management server is configured to manage an offline downloading process, initialize the offline downloading task request to the file dividing and segmenting server, query downloading state of the segmented file from the file dividing and segmenting server, and inform the downloading client to download, when at least one segmented file has been downloaded offline;

the file dividing and segmenting server is configured to logically divide a destination file requesting to be downloaded offline into more than one segmented file, inform the offline downloading server to download the segmented files, and receive the downloading state of each segmented file; and

the offline downloading server is configured to download the segmented file to the cloud storage server offline, monitor the downloading state of the segmented file, and synchronize to the file dividing and segmenting server.

A method for offline downloading a network resource file, which includes:

logically dividing, by an offline downloading server end, a destination file requesting to be downloaded offline into more than one segmented file to download offline;

monitoring, by the offline downloading server end, downloading state of a segmented file and informing a downloading client to download, when at least one segmented file has been downloaded offline; and

downloading, by the downloading client, the segmented file downloaded offline from the offline downloading server side.

Compared with the prior art, in accordance with examples of the present disclosure regarding offline downloading of a large file and a super large file (such as a file larger than 8 G), the file may be logically divided first and the downloading progress of each segmented file may be respectively maintained. In place of waiting for completion of the download of the whole destination file, as long as one segmented file has been downloaded offline, a downloading client may be informed to retrieve (that is, download) the segmented file from the offline downloading server side. Thus, during the process of the offline downloading server side downloading offline, the downloading client may also download from the offline downloading server side, so as to shorten the overall downloading time of a network resource file, which may be especially useful for the download and distribution of large files and super large files.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating sharing and downloading network resources in P2SP technologies;

FIG. 2 is a diagram illustrating structure of an offline downloading system and how the offline downloading system may download a network resource file;

FIG. 3 is a diagram illustrating structure of a system for offline downloading network resource files, in accordance with an example of the present disclosure;

FIG. 4 is a diagram illustrating structure of an offline downloading system with an offline downloading server cluster, in accordance with an example of the present disclosure and

FIG. 5 is a flowchart illustrating a method for offline downloading a network resource file, in accordance with an example of the present disclosure.

Corresponding reference numerals indicate corresponding parts throughout the several views of the drawings.

### DETAILED DESCRIPTION

Example embodiments will now be described more fully with reference to the accompanying drawings.

Detailed descriptions of the present disclosure may be further provided in the following, accompanying attached figures and specific examples.

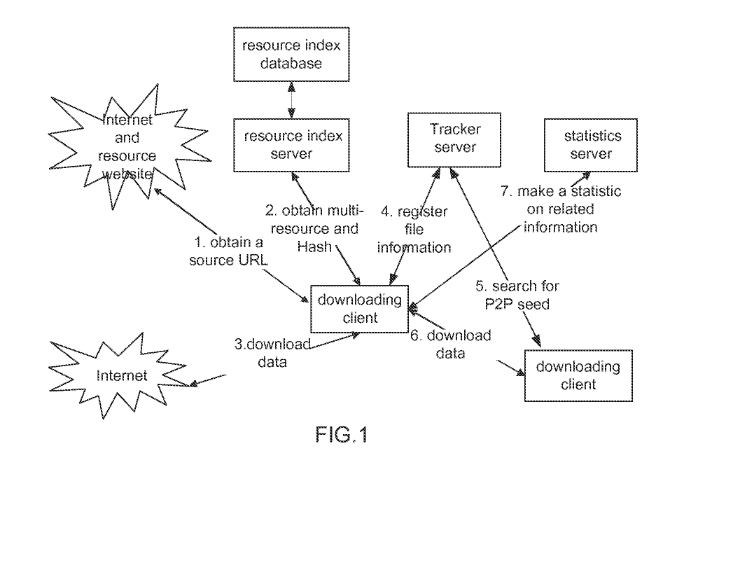

FIG. 1 is a flowchart illustrating sharing and downloading network resources in the P2SP technologies. With reference to FIG. 1, a P2SP network may include a downloading client, a resource index server, a Tracker server and a statistics server.

The downloading client is mainly configured to execute the following operations:

Periodically report online status and locally owned resource information to the Tracker server.

Search for multi-resource Universal Resource Locator (URL) set, hash, and file checksum information in the resource index server by using a source URL and download data from the URL set source.

Search for Peer in the Tracker server simultaneously.

After completing a downloading task, report the following information about the downloading task to the statistics server, such as downloading time, downloading speed, downloading result, file size, and source link of the downloading, as well as downloading speed and downloading time obtained from different URL sources.

During the downloading process, when realizing that a complete data segment has been downloaded, check the downloaded data segment. When realizing that the data segment is wrong, report to the statistics server.

The resource index server is mainly configured to execute the following operations:

Receive a search for file hash from a downloading client, including an offline downloading server of cloud side, by translating a URL as an index entry.

Receive a search for downloaded multi-URL resource set from the downloading client, including an offline downloading server of cloud side, by translating the URL as the index entry.

Provide segmented file checksum information so that the downloading client may check the validity of downloaded data.

The resource index database is mainly configured to store indexes and resource records for all of the URL resource databases in a P2SP system.

The Tracker server is mainly configured to execute the following operations:

Provide registration for each downloading client requesting to join a network, and execute feedback for an IP address list possessing the resource node.

Receive online status reports from the downloading client, generate a node list for each resource, and execute feedback when a node requests to download the task.

The statistics server is mainly configured to receive a report from the downloading client for information of the downloading process and downloading completion, such as URL downloading speed, downloading time, connection status, downloading result, and file size, and subsequently write into a water flow log to facilitate subsequent statistics and analysis.

With reference to FIG. 1, in the P2SP network, the method for downloading network resources mainly includes the following:

When required to download network resources, a user may obtain an original URL link from the Internet or a resource website.

The user may take the original URL link as an entry and search in the resource index sever for a multi-resource URL set and hash value of the file.

The downloading client may download data from the URL searched out.

When the downloading is finished, register file information to the Tracker server.

Other downloading clients may search out the P2P seed by using the Tracker server, the foregoing P2P seed may refer to a downloaded seed or a seed being downloaded.

Other downloading clients may start to search for multi-source P2P downloading, and exchange data among Peers.

When downloading is finished, report related statistics information to the statistics server.

Regardless of which of the downloading technologies mentioned above is employed, a downloading client of a user needs to directly utilize the foregoing downloading technologies to download network resource files. When required to download some unpopular network resources or larger files, a user generally needs to be online for an extended period of time, which may waste time and consume a large bandwidth. Thus, an offline downloading technical solution will benefit the current industry.

The offline downloading is defined when a server downloads a certain network resource as a high-speed proxy and transfers the network resource to an offline space. When the downloading is finished in the proxy, a downloading client of a user may download from the offline space to the local machine. By using the offline downloading processing mode, functions of network acceleration may be implemented. Presently, the offline downloading processing mode has been popularly used.

The nature of offline downloading implies that a server may first download a certain network resource for a user as a downloading tool. For example, under the circumstance that a resource is unpopular due to relatively slow downloading speed, when a user directly utilizes the downloading client of a local machine to download, the downloading duration may be longer. When the user employs the offline downloading technologies, a server of a Service Provider (SP) may download for the user. Subsequently, the user may turn off the downloading client or machine so as to save time, bandwidth, and power consumption. When the server has completed the offline downloading, the user may download from the server to the client computer at a high speed. Much online waiting time may be saved by using the offline downloading. It is particularly important to note that users may save bandwidth resources to process other tasks.

The foregoing technical solution of offline downloading may possess the following characteristics:

Accelerate the download of unpopular resources. The offline downloading may solve the problem of slow speed for downloading unpopular resources, on-hook of a longer time for users. By utilizing bigger bandwidth of an offline server, compared with common ADSL network, a file may be downloaded more quickly to a dedicated server of a user. When the downloading is finished, the user may stably download the file from the dedicated server to the local computer of the user with a high speed. Since the bandwidth of the offline server is much larger than that of the ADSL network, the offline server may provide a downloading speed larger than that of the ADSL network.

Stably improve downloading speed. When employing the offline downloading to complete a common task, speed may be faster and more stable. An exclusive membership server may provide a stable downloading speed for members. When downloading directly instead of employing the offline downloading, the downloading speed may be in a volatile state and unpredictable, which may be limited by network environment. However, the offline downloading may provide a stable speed.

Solve the problems of blocked network and limited network. When a P2P network or a P2SP network is limited, offline downloading may still run with a high speed. The member dedicated server of offline downloading may provide 7-24 hours of continuous high-speed downloading for users. As a result, the downloading efficiency of the user may be higher, and the utilization of downloading time may be higher. A user's dedicated server may continuously download files for the user, when the user is not on-hook, such that the user's valuable time may be saved.

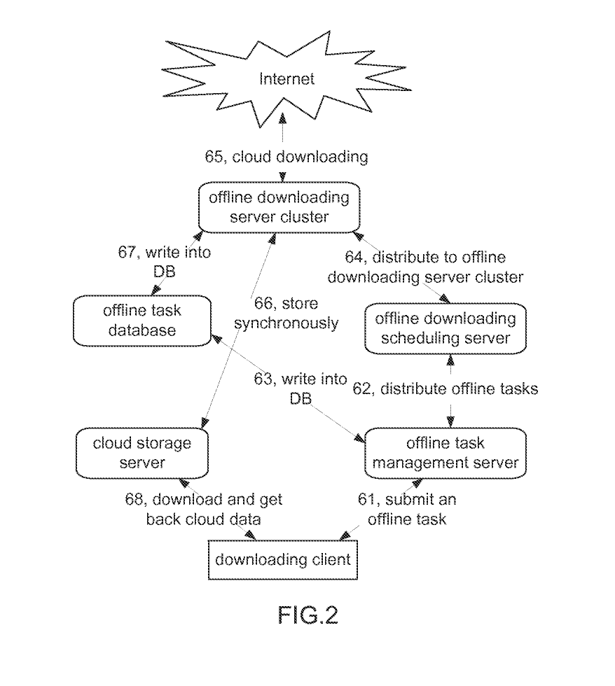

FIG. 2 is a diagram illustrating structure of an offline downloading system and how the offline downloading system may download a network resource file. With reference to FIG. 2, the offline downloading system may include a downloading client, an offline task management server, an offline downloading scheduling server, an offline downloading server cluster, an offline task database, and a cloud storage server. Each server mentioned above may be an independent set physical server, or may be a service functional module, which may be set within one or more than one physical server.

With reference to FIG. 2, the main procedure of the technical solution of offline downloading may be as follows:

The downloading client may submit an offline downloading task request to the offline task management server, which may include a downloading address of a file to be downloaded, such as a HyperText Transfer Protocol (HTTP) link, Electronic Mule email (eMule) link or a BitTorrent (BT) downloading seed corresponding to the file downloading.

After receiving the offline downloading task request submitted by the user, the offline task management server may first search for Db mapping records in the offline task database and determine whether resources requesting to be downloaded have been downloaded and stored in the cloud storage server. If so, the offline task management server may directly inform the downloading client that the offline downloading was successful. The downloading client may directly download the resources from the cloud storage server and meanwhile may use the P2SP technologies to download. If not, the offline task management server may transmit the downloading address of the offline downloading task request to the offline downloading scheduling server, e.g., transmit the URL link, eMule link or BT seed file information of corresponding HTTP to the offline downloading scheduling server, and simultaneously write the offline downloading task information into the offline task database.

The offline downloading scheduling server may schedule offline tasks based on load of the offline downloading server cluster.

The offline downloading server cluster may initiate the downloading based on the downloading address and download data from the Internet. During the downloading process, the downloading server cluster may employ P2SP downloading technologies and simultaneously report downloading state information (including information such as downloading progress and downloading speed) to the offline downloading scheduling server. Subsequently, the offline downloading scheduling server may report to the offline task management server.

The downloaded data may be simultaneously synchronized to the cloud storage server. Meanwhile, the downloading result may be written into the offline task database. That is, the offline task database may store hash result data of the final file generated by offline downloading, which may form a mapping record with the original link of the corresponding downloading task request.

Based on the reported downloading state information, after determining that the network resource file has been downloaded, the offline task management server may inform the downloading client to download the corresponding file from the cloud storage server. At this time, the downloading client may directly download the file from the cloud storage server.

With the explosive growth of digital contents, the size of network resource files is also growing. For example, common size of an installation package of a downloading client for a network game may be hundreds of M, several G, or a dozen G. For another example, in regard to movie files of Blu-ray format in a High Definition (HD) video, generally speaking, a Blu-ray format movie file may be larger than 20 G. In addition, sizes of some files cannot be divided, such as system backup software, installation program, professional image, and Power Point (PPT), which have a tendency to be increased gradually. Subsequently, contents of large files of the Internet become more prevalent, and the distribution of large files becomes an important problem to be solved.

The duration of downloading a large file may be relatively long. Considering an HD movie of 20 G, when downloading with a full speed based on a typical ADSL bandwidth of users, such as 2 M, the required downloading duration may be 20 GB/2 Mb=10*1000*8 s=80000 s=22.22 hours. When downloading with a 4 M network, the downloading duration may be more than 11 hours.

However, based on the foregoing offline downloading technologies, no matter the size of the file, the file may be downloaded and delivered to the local client before the file has been downloaded in the server side. Part of the data downloaded by the server may not accelerate ongoing file downloading in the local client. Subsequently, partially completed data files may not be a factor. Thus, for a large file (e.g., a super large file more than 8 G), current offline downloading schemes may have the following deficiencies.

The duration of a user waiting for completion of downloading a large file is excessive. The duration of the offline downloading server to complete downloading is also excessive. In addition, the duration of the downloading client to return the downloaded file from the cloud storage server is also excessive. The foregoing two processes may be not executed simultaneously. Subsequently, the total downloading duration of a large file may be extensive. In the present disclosure, a file dividing and segmenting server as well as a segmented state database have been added to the foregoing offline downloading system. By modifying and integrating the foregoing offline downloading system, a complete system for dividing, distributing, and downloading large files and super large files may be formed.

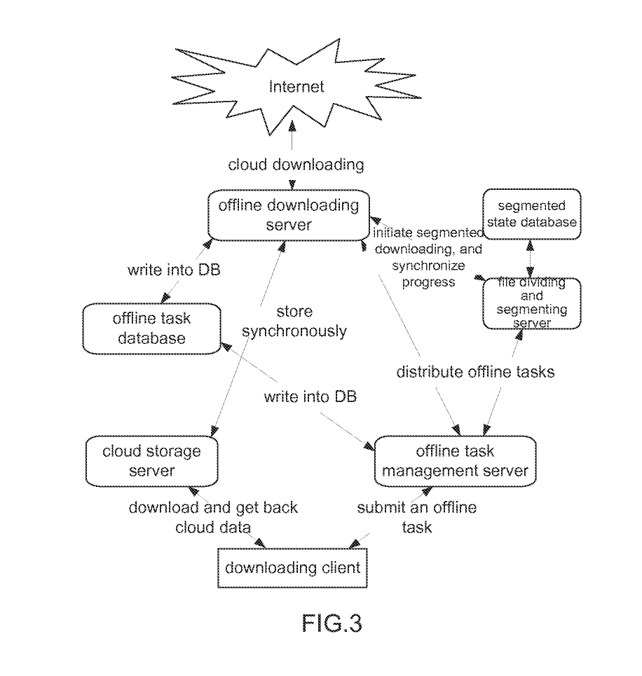

FIG. 3 is a diagram illustrating structure of a system for offline downloading network resource files, in accordance with an example of the present disclosure. With reference to FIG. 3, the offline downloading system may include a downloading client, an offline task management server, an offline task database, an offline downloading server, a cloud storage server, a file dividing and segmenting server, as well as a segmented state database.

The offline task management server is configured to execute the following operations.

Receive an offline downloading task submitted by the downloading client and generate a unique identification number for each independent offline downloading task.

Write original link information about the offline downloading task into the offline task database.

Determine whether resources requesting to be downloaded have been downloaded and stored in the cloud storage server, based on DB mapping records of the offline task database. When determining that the resources requesting to be downloaded have been downloaded and stored in the cloud storage server, directly inform the downloading client that the offline downloading is successful. As a result, the downloading client may directly download the resources from the cloud storage server, while employing the P2SP technologies to download the resources, or transmit the offline downloading task request to the offline downloading server.

Receive downloading progress reported by the offline downloading server, which is available for the downloading client to query offline downloading progress.

When the downloading client needs to retrieve the data when the offline downloading has been completed, an entry address URL is provided for retrieving the data for the downloading client, and the URL may be used as a downloading source of the downloading client.

After receiving the offline downloading task request from the downloading client, the offline task management server is further configured to determine whether size of the requested destination file (that is, the file requesting to be downloaded) is larger than a preset threshold (such as 8 G). When determining that the file is a large file, logic dividing processing is necessary to be executed. The offline task management server is further configured to transmit the offline downloading task request to the file dividing and segmenting server to be processed, otherwise, the offline task management server may employ processing mode in the prior art.

The offline task management server may determine a unique marker and file state of each segment in the file, based on file size segmented rule, and receive a downloading state query from the offline downloading server.

Query the segmented file downloading state in the segmented state database, by using the file dividing and segmenting server, and inform the downloading client to download, when at least one segmented file has been downloaded offline.

The file dividing and segmenting server is configured to execute the following operations. Logically divide the destination file requesting to be downloaded offline into more than one segmented file, based on a file dividing and segmenting rule corresponding to a file of different type and different protocol. Inform the offline downloading server to download the segmented file. Initialize state of the segmented file in the segmented state database. Receive the downloading state of the segmented file returned by the offline downloading server, and store into the segmented state database. That is, the downloading state of the segmented file in the offline downloading server may be synchronized to the file dividing and segmenting server, and stored into the segmented state database.

The segmented state database is configured to execute the following operations. Store a downloading state corresponding to each segmented file, which is obtained after dividing and segmenting a large file. The segmented state database is also available for the file dividing and segmenting server to query downloading state of a segmented file. The primary key of records in the segmented state database is the unique ID of a segmented file. Therefore, the segmented state database may be an optional component. The downloading state may also be recorded in a data file of the file dividing and segmenting server.

The offline downloading server is configured to execute the following operations. Obtain an original link of an offline downloading request from the offline task database and perform a cloud downloading. That is, offline download a segmented file to the cloud storage server. Monitor downloading state information of the segmented file, including information, such as downloading progress and downloading speed, and return to the file dividing and segmenting server as well as the offline task management server. The offline downloading server may also provide service support for the downloading client to get back result data of offline downloading when the offline downloading is completed. The offline downloading server may use reserved bandwidth to output data needed by a user, and write the hash result data of the final file generated by the offline downloading into the offline task database. In a simple scenario, the offline downloading server cluster may be a server.

The offline task database is configured to execute the following operations. Store original link information for the offline downloading task, and be available for the offline downloading server to query. Store the hash result data of the final file generated by the offline downloading, form a mapping record with the original link of corresponding downloading task request, and be available for the offline task management server to query. The offline task database may be an optional component, which may be replaced with one data file in the offline task management server.

The cloud storage server is configured to store data downloaded by the offline downloading server, and is taken as the data source for the downloading client to download and retrieve data downloaded offline.

The downloading client may be a downloading client with functions of existing P2S downloading client, P2P downloading client, or P2SP downloading client. In addition to possessing functions of the foregoing downloading client, the downloading client in the example is further configured to submit an offline downloading task request to the offline task management server, and query progress information of the offline task. The downloading client is further configured to download a segmented file, offline downloading of which has been completed, from the cloud storage server. After downloading a segmented file of a large file, the downloading client is further configured to take the unique ID of the segmented file as the label of a local file, and register to a Tracker server in a P2P network or P2SP network. By executing the foregoing operations, the local segmented file may be taken as a downloading source of other downloading clients in the P2P network or P2SP network. The downloading client is further configured to preview contents of the segmented file, after downloading the segmented file from the offline downloading server side, such that a user may determine whether the destination file is required by the user.

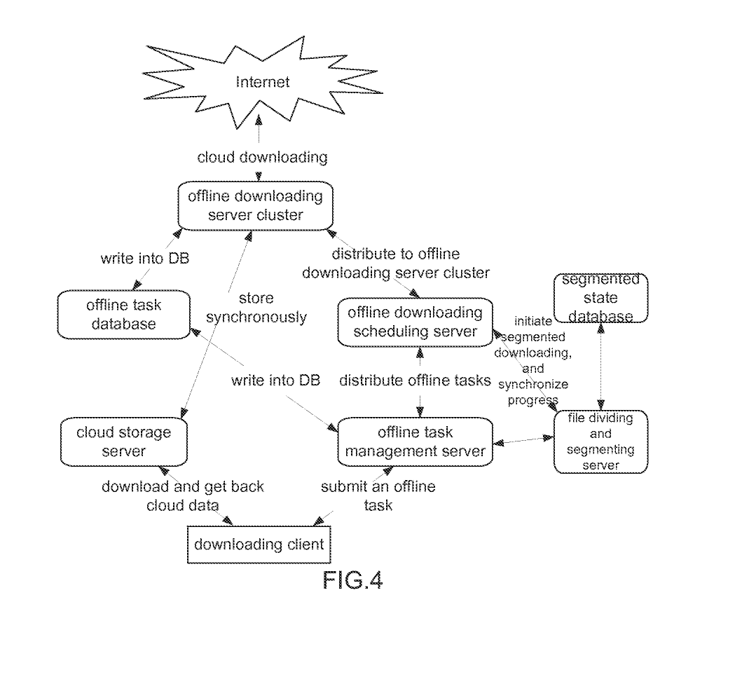

In an example of the present disclosure, the offline downloading server may be more than one offline downloading server cluster. FIG. 4 is a diagram illustrating structure of an offline downloading system with an offline downloading server cluster.

With reference to FIG. 4, when the system includes the offline downloading server cluster, the system may further include an offline downloading scheduling server, which is mainly configured to execute the following operations.

Receive load information reported by a node in the offline downloading server cluster.

After receiving offline downloading task requests from the offline task management server, based on the load information of the offline downloading server, dynamically schedule offline downloading tasks to different nodes of the offline downloading server cluster to execute downloading tasks for a specific destination file and segmented file.

Receive downloading state information (including information such as downloading progress and downloading speed) for a destination file and segmented file reported by the offline downloading server node, and meanwhile transmit the downloading state information to the offline task management server, as well as the file dividing and segmenting server. In the example illustrated with FIG. 4, the downloading state of the segmented file monitored by the offline downloading server may be first synchronized to the offline downloading scheduling server, and then be synchronized by the offline downloading scheduling server to the file dividing and segmenting server. As a result, the offline downloading scheduling server may synchronize the downloading state of the segmented file to the offline task management server. The offline task management server may generate the total downloading progress of the destination file and synchronize to the downloading client for users to view.

Filter the same offline downloading requests. It is necessary to transmit the same offline downloading request to the offline downloading server cluster once. Different users may share offline downloading progress information of one task.

In addition to specific functions of the foregoing offline downloading server, the offline downloading server cluster is further configured to execute the following operations. Register address of the offline downloading server cluster to the offline downloading scheduling server. Report disk space of the offline downloading server cluster, and Central Processing Unit (CPU), load information to the offline downloading scheduling server, and be available for the offline downloading scheduling server to execute the downloading scheduling dynamically and balanced, based on loads. Receive scheduling of the offline downloading scheduling server. Obtain the original link of the offline downloading request from the offline task database, and perform the cloud downloading.

In the present disclosure, each previously mentioned server may be an independent set physical server, or may be a service functional module, which is set in one or more than one physical server.

The method for offline downloading network resource files by an offline downloading system in the present disclosure will be described in the following.

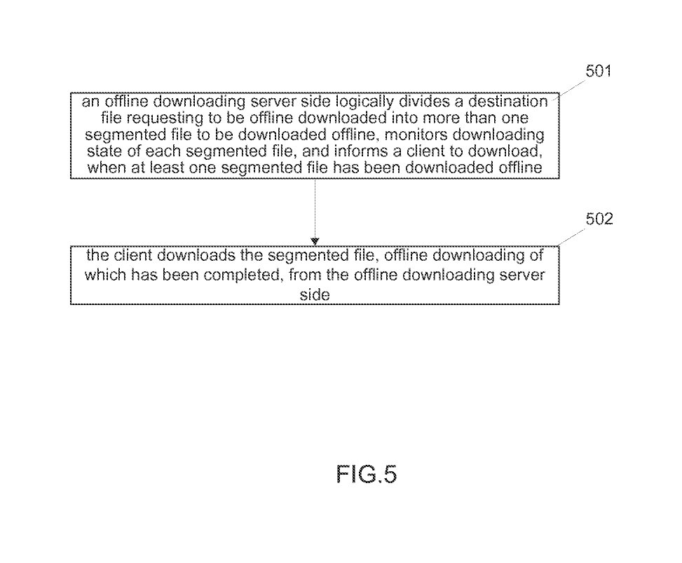

FIG. 5 is a flowchart illustrating a method for offline downloading network resource files, in accordance with an example of the present disclosure. As shown in FIG. 5, the method may include the following.

In block 501, an offline downloading server side may logically divide a destination file requesting to be offline downloaded into more than one segmented file, offline download more than one segmented file, and monitor the downloading state of each segmented file. When the offline downloading of at least one segmented file is completed, the offline downloading server side may inform a downloading client to download. The offline downloading server side refers to the server side in the offline downloading system of the foregoing FIG. 3 and FIG. 4. The offline downloading server side in FIG. 3 refers to the offline task management server, the file dividing and segmenting the server, the segmented state database, the offline downloading server, the offline task database, and the cloud storage server. The offline downloading server side in FIG. 4 refers to the offline task management server, the offline downloading scheduling server, the file dividing and segmenting server, the segmented state database, the offline downloading server cluster, the offline task database, and the cloud storage server.

In block 502, the downloading client may download the segmented file, offline downloading of which has been completed, from the offline downloading server side.

In the present disclosure, the downloading process of large files and super large files (e.g., a file larger than 8 G) is divided and parsed. For example, a logical division is performed on a super large file based on a determined logical division rule, and the super large file is divided into multiple segmented files of specific size or specific number. Each segmented file is an independent entity. One entity monitors and maintains the downloading progress state of each segmented file. One entity informs the downloading client user to download and get back the segmented file from the offline downloading server side, when at least one segmented file has been downloaded, that is, partial file contents have been downloaded, instead of waiting for the whole file to be downloaded.

Specific execution process of the foregoing method in the present disclosure will be described in the following, which includes the following blocks.

In block 601, the downloading client may submit an offline downloading task request to the offline task management server. The offline downloading task request may include information, e.g., size, downloading address of the destination file to be downloaded, such as HTTP link, or eMule link or BT downloading seed of the corresponding file.

In block 602, the offline task management server determines whether the size of the destination file requesting to be offline downloaded is larger than a preset threshold (e.g., which may be set as 8 G). When determining that the size of the destination file requesting to be offline downloaded is larger than the preset threshold, the offline task management server determines that the destination file is a large file or a super large file, which needs to be downloaded after dividing and segmenting, and proceeds with subsequent blocks. Conversely, the offline task management server may determine that downloading after dividing and segmenting is not necessary, and will proceed with the existing processing mode. Block 602 is an optional block. All of the destination files may be downloaded after dividing and segmenting.

In block 603, the offline task management server may search for downloading result records in the offline task database and determine whether the destination file requesting to be downloaded has been downloaded and stored in the cloud storage server. When determining that the destination file requesting to be downloaded has been downloaded and stored in the cloud storage server, the offline task management server may directly inform the downloading client that the offline downloading is successful, and inform the downloading client about downloading information of each segmented file of the destination file. Subsequently, the downloading client may directly download the segmented file from the cloud storage server based on the downloading information, and meanwhile may employ the P2SP technologies to download from downloading sources of other clients and then terminate the processing flow. Conversely, the offline task management server may transmit the offline downloading task request to the file dividing and segmenting server, e.g., transmit the URL link, eMule link or BT seed file information of corresponding HTTP to the file dividing and segmenting server, and write the offline downloading task information into the offline task database.

In block 604, the file dividing and segmenting server may logically divide the destination file requesting to be offline downloaded into more than one segmented file, based on a file dividing and segmenting rule corresponding to a file of different protocol and different type.

In block 604, since the destination file has not been downloaded, the destination file requesting to be offline downloaded may be logically divided into more than one segmented file, and a unique ID of each segmented file may be set. The specific mode of the logical division may be as follows.

For a super large file, divide and segment the super large file based on file size. The segmenting file rule may be associated with file size. The segment may be larger when accompanied with larger file. There are two kinds of specific dividing methods. The first kind is to logically divide, based on a fixed segmenting number. That is, the segmented number is fixed and the size of each segmented file may be not play a role. The second kind is to divide logically, based on a fixed size of each segmented file. That is, except for the last segmented file varying, the size of each of the remaining segmented files is fixed, and segmented number is not fixed. For example, the size of each of the remaining segmented files is 100 M; however, the total number of segmented files is not fixed. In practical processing procedure, specific dividing modes may be determined based on requirements. Generally speaking, regarding a larger file, e.g., a file larger than 50 G, the first method may be employed. For others, the second method may be employed. For example, based on file downloading progress, a file may be divided into 1,024 parts equally. Each part may occupy one in one thousand of the total progress. For a file of 100 G, each segment may be 100 M. When defining that a large file is a file larger than 8 G, one segment may be 80/1024=8 M.

Before being divided and segmented, each destination file takes a unique hash value as a marker. Specific methods for setting the unique ID of each segmented file of the destination file may be different, based on a different type of a destination file, which mainly include three methods, as listed to follow.

(1) When the destination file is a file with a URL marker, calculate the hash value of the URL of the destination file. Take the hash value as a first part of the unique ID of each segmented file. Each segmented file has a unique serial number in the destination file, which may be identified with an integer. The latter part of the unique ID of each segmented file is the serial number of the segmented file within the destination file, which may be combined with the first part to form the unique ID of 24 bytes.

(2) When the task requesting to be offline downloaded is an eMule task, that is, the destination file is a file with an eDonkey2000 network (ed2k) link marker, calculate the hash value (such as MD5 information, which may generally be 16 bytes) of the destination file, based on file contents. Take the hash value as the first part of the unique ID of each segmented file. The latter part of the unique ID of each segmented file may be the serial number of the segmented file within the destination file.

(3) When a BT seed file is requested to be downloaded offline, the situation may be more complicated. Since a BT seed is a set of a downloaded file, one BT seed may include more than one file. For each destination file in a BT seed, calculate the hash value of the BT seed (that is, torrent file). Add the hash value to the serial number of the destination file in the BT seed, and take the result as the first part of the unique ID of each segmented file in the destination file. The latter part of the unique ID of each segmented file is the serial number of the segmented file in the destination file. In subsequent processes, each segmented file corresponds to a unique downloading state. When the BT intermediate file is a small file, which does not achieve the limit for dividing a super large file, the dividing may be not necessary.

In block 605, the file dividing and segmenting server may determine an offset of the segmented file within the destination file, based on size and unique ID (essentially the serial number of the unique ID) of each segmented file after being divided logically, and transmit an offline downloading request, which includes the downloading address of the destination file, the unique ID of each segmented file, and the offset within the destination file, to the offline downloading server, so as to offline download the destination file. Meanwhile, the file dividing and segmenting server may initialize the state of the segmented file to the segmented state database. The initializing refers to setting the unique ID of the segmented file, as well as downloading progress 0, in the segmented state database. When the offline downloading server cluster is employed, the foregoing offline downloading request may be transmitted to the offline downloading scheduling server. And then, the offline downloading scheduling server may schedule one or more than one offline downloading server to offline download the destination file, based on load of the offline downloading server cluster.

In block 606, the offline downloading server may download the destination file, based on the downloading address of the destination file, that is, perform the cloud downloading. During the downloading process, the offline downloading server may employ the P2SP downloading technologies of the offline downloading server. During the process of downloading the destination file, the offline downloading server may monitor the offline downloading state of each segmented file (this at least includes downloading progress, which may further include information such as downloading speed) in real time, based on the offset of the segmented file in the destination file, that is, the smallest downloading unit is a segmented file. In addition, the offline downloading server may synchronize in real time the downloading state information of the segmented file to the file dividing and segmenting server. Subsequently, the file dividing and segmenting server may store the downloading state information of the segmented file to the segmented state database, and synchronize the downloading state information of the total destination file to the offline task management server. Alternatively, when the offline downloading server cluster is employed, the downloading state information of the segmented file and the total downloading state information of the destination file may be synchronized to the offline downloading scheduling server. Consequently, the offline downloading scheduling server may synchronize the downloading state information of the segmented file to the file dividing and segmenting server. The file dividing and segmenting server may store the downloading state information of the segmented file to the segmented state database. The offline downloading scheduling server may also synchronize the total downloading state information of the destination file to the offline task management server.

In block 607, when downloading the segmented file, the offline downloading server may concurrently store the downloaded segmented file data to the cloud storage server. The cloud storage server may return the storage address of the segmented file (the URL address of the segmented file stored in the cloud storage server) to the offline downloading server. As a result, the offline downloading server may return the unique ID and storage address of the segmented file to the offline task management server, or return to the offline task management server via the offline downloading scheduling server. Alternatively, the offline downloading server may only return the unique ID of the segmented file to the offline task management server. The offline task management server may calculate the storage address corresponding to the unique ID, based on the same algorithm for the cloud storage server to calculate the storage address. The offline downloading server may write the storage address of each segmented file into the offline task database. After downloading all of the segmented files in the destination file, the offline downloading server may write the downloading result into the offline task database.

In block 608, when determining that one segmented file has been downloaded by the offline downloading server, based on the synchronized downloading state information, the file dividing and segmenting server may inform the offline task management server. The offline task management server may transmit the storage address of the segmented file to the downloading client. Subsequently, the downloading client may download the segmented file from the cloud storage server, based on the storage address. Alternatively, the offline task management server may only transmit the unique ID of the segmented file to the downloading client, and release the unique ID and storage address of the segmented file to a resource index database in a P2P network or a P2SP network connecting with the offline downloading system. The downloading client may obtain the storage address of the segmented file from the P2P network or the P2SP network, based on the unique ID of the segmented file, and may download the corresponding segmented file from the cloud storage server, based on the storage address.

In block 609, after downloading the segmented file from the offline downloading server side, the downloading client may further preview contents of the segmented file, due to the fact that the segmented file is an independent file. Thus, the downloading client may learn in advance whether the downloaded destination file is needed by the downloading client, particularly for a video file, and the downloading client may preview contents after downloading partial contents. Compared with the scheme in the prior art, file contents may be viewed only if the whole destination file has been downloaded to a local client. By employing the technical solution of the present disclosure, unnecessary waiting duration may be reduced. When learning that the destination file is not needed by a user, downloading may be promptly abandoned, and the waste of bandwidth and time may be avoided.

In block 610, after downloading one segmented file, the downloading client may also take the unique ID of the segmented file as the marker of the local file, and register to a Tracker server in the P2P network or P2SP network connecting with the local client. By executing the foregoing operation, the local segmented file may be taken as a downloading source of another client in the P2P network or P2SP network. The cloud storage server may be taken as a stable source, such that the downloading speed of the whole destination file may be further improved.

In block 611, after downloading all of the segmented files of the destination file, the downloading client may calculate the offset of each segmented file in the destination file, based on size and unique ID of the segmented file, and combine all of the segmented files to form one destination file, based on the offset.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A system for offline downloading a network resource file, comprising a downloading client, an offline task management server, an offline downloading server, a cloud storage server, a file dividing and segmenting server, wherein
the downloading client is configured to initiate an offline downloading task request, and download a segmented file, which has been downloaded offline, from the cloud storage server;
the offline task management server is configured to manage an offline downloading process, initialize the offline downloading task request to the file dividing and segmenting server, query downloading state of the segmented file from the file dividing and segmenting server, and inform the downloading client to download, when at least one segmented file has been downloaded offline;
the file dividing and segmenting server is configured to logically divide a destination file requesting to be downloaded offline into more than one segmented file, inform the offline downloading server to download the segmented files, and receive downloading state about each segmented file; and
the offline downloading server is configured to offline download the segmented file to the cloud storage server, monitor the downloading state of the segmented file, and synchronize to the file dividing and segmenting server.

2. The system according to claim 1, wherein the offline downloading server is more than one offline downloading server cluster, and the system further comprises an offline downloading scheduling server, which is configured to schedule a server in the offline downloading server cluster to download a corresponding file, wherein
the downloading state of the segmented file monitored by the offline downloading server may be synchronized to the offline downloading scheduling server, and be synchronized by the offline downloading scheduling server to the file dividing and segmenting server.

3. The system according to claim 1, wherein the system further comprises an offline task database and a segmented state database;
the offline task database, which is connected with the offline task management server and the offline downloading server, is configured to store a downloading task and a downloading result during the offline downloading process; and
the segmented state database, which is connected with the file dividing and segmenting server, is configured to store the downloading state of the segmented file.

4. A method for offline downloading a network resource file, comprising:
logically dividing, by an offline downloading server end, a destination file requesting to be downloaded offline into more than one segmented file to download offline;
monitoring, by the offline downloading server end, downloading state of a segmented file, and informing a downloading client to download, when at least one segmented file has been downloaded offline; and
downloading, by the downloading client, the segmented file downloaded offline from the offline downloading server side.

5. The method according to claim 4, wherein logically dividing the destination file requesting to be downloaded offline into more than one segmented file to download offline, and monitoring the downloading state of the segmented file comprise:
logically dividing the destination file requesting to be downloaded offline into more than one segmented file, setting a unique identity (ID) of each segmented file, determining an offset of each segmented file in the destination file, based on size and unique ID of each segmented file; downloading the destination file based on downloading address of the destination file, and monitoring offline downloading state of each segmented file, based on the offset of each segmented file in the destination file.

6. The method according to claim 5, wherein the destination file is a file with a Uniform Resource Locator (URL) marker, and setting the unique ID of each segmented file in the destination file comprises:
calculating a hash value of URL of the destination file, taking the hash value as a first part of the unique ID of each segmented file, and taking a serial number of each segmented file in the destination file as a latter part of the unique ID of each segmented file.

7. The method according to claim 5, wherein the destination file is a file with an eDonkey2000 network (ed2k) link marker, and setting the unique ID of each segmented file in the destination file comprises:
calculating a hash value of the destination file based on file contents, taking the hash value as a first part of the unique ID of each segmented file, and taking a serial number of each segmented file in the destination file as a latter part of the unique ID of each segmented file.

8. The method according to claim 5, wherein the destination file is a file in a Bit Torrent (BT) seed, and setting the unique ID of each segmented file in the destination file comprises:
calculating a hash value of the BT seed, adding the hash value to a serial number of the destination file in the BT seed and obtaining a result, taking the result as a first part of the unique ID of each segmented file in the destination file, taking a serial number of each segmented file in the destination file as a latter part of the unique ID of each segmented file.

9. The method according to claim 4, further comprising:
after downloading all segmented files in the destination file from the offline downloading server side, combining, by the downloading client, the all segmented files into one destination file.

10. The method according to claim 4, further comprising:
after downloading the segmented file from the offline downloading server side, previewing, by the downloading client, contents of the segmented file

11. The method according to claim 4, further comprising:
after downloading one segmented file, taking, by the downloading client, the unique identity (ID) of the segmented file as a marker of a local file, registering to a Tracker server in a Peer-to-Peer (P2P) network, or in a Peer to Server & Peer (P2SP) network, and taking the segmented file as a data source for another client in the P2P network or P2SP network to download the segmented file.

12. The method according to claim 4, wherein informing the downloading client by the offline downloading server side to download the segmented file comprises:
informing the downloading client, by the offline downloading server side, storage address of the segmented file in the offline downloading server side;
downloading, by the downloading client, the corresponding segmented file from the offline downloading server side, based on the storage address; or,
releasing, by the offline downloading server side, the unique ID and storage address of the segmented file downloaded offline, to a Peer-to-Peer (P2P) network or a Peer to Server & Peer (P2SP) network, and informing the downloading client about the unique ID of the segmented file;
obtaining, by the downloading client, the storage address of the segmented file from the P2P network or the P2SP network, based on the unique ID of the segmented file, and downloading the corresponding segmented file from the offline downloading server side, based on the storage address.
